(19) United States
(12) Patent Application Publication
(10) Pub. No.: US 2009/0320238 A1
(43) Pub. Date: Dec. 31, 2009

(54) CAM INTERFERENCE ASSEMBLY OF HINGE AND FOLDABLE DEVICE

(75) Inventor: CHEN-WEI CHIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/198,591

(22) Filed: Aug. 26, 2008

(30) Foreign Application Priority Data
Jun. 25, 2008 (CN) 200820301286.7

(51) Int. Cl. E05D 7/00

(52) U.S. Cl. 16/221

(57) ABSTRACT

A cam interference assembly of a hinge includes a cylinder-shaped first element and a cylinder-shaped second element. The first element defines a through hole in a central portion of the first element. A first mating surface of the first element defines a plurality of depressed portions and a plurality of first recessed cavities capable of retaining oil. The second element defines a fixing hole in a central portion of the second element. A second mating surface of the second element defines a plurality of raised portions configured for engaging with the corresponding plurality of depressed portions, and a plurality of second recessed cavities capable of retaining oil. The first element is rotatable relative to the second element. The first mating surface and the second mating surface face each other.

### BACKGROUND

1. Field of the Invention

The present invention relates to a cam interference assembly of a hinge, and a foldable device using the cam interference assembly.

2. Description of Related Art

A foldable device, such as a notebook computer and a clamshell mobile phone, generally includes a base and a cover pivotally mounted to the base with a hinge. The hinge generally includes a first element and a second element for positioning the cover during rotation. The first element includes two raised portions and the second element includes two depressed portions for receiving the raised portions. When the cover is rotated, the first element is rotated relative to the second element, the raised portions are moved out from the corresponding depressed portions, resulting in friction between the first and second elements, thereby causing the first and second elements to wear out.

What is needed, therefore, is a hinge having a cam interference assembly which can provide balanced rotation of the hinge.

### BRIEF DESCRIPTION OF THE DRAWINGS

FIG. 1 is an exploded, isometric view of an embodiment of a cam interference assembly, the cam interference assembly including a first element and a second element.

FIG. 2 is another exploded view of the cam interference assembly of FIG. 1, but from a different aspect.

FIG. 3 is an assembled, isometric view of the cam interference assembly of FIG. 1.

FIG. 4 is an assembled, isometric view of a foldable device, the foldable device including the cam interference assembly.

FIG. 5 is a plan view of the cam interference assembly of FIG. 1.

FIG. 6 is a plan view similar to FIG. 5, except that the second element is rotated 45 degrees relative to the first element.

FIG. 7 is a plan view similar to FIG. 5, except that the second element is rotated 90 degrees relative to the first element.

FIG. 8 is a plan view similar to FIG. 5, except that the second element is rotated 180 degrees relative to the first element.

### DETAILED DESCRIPTION OF THE EMBODIMENTS

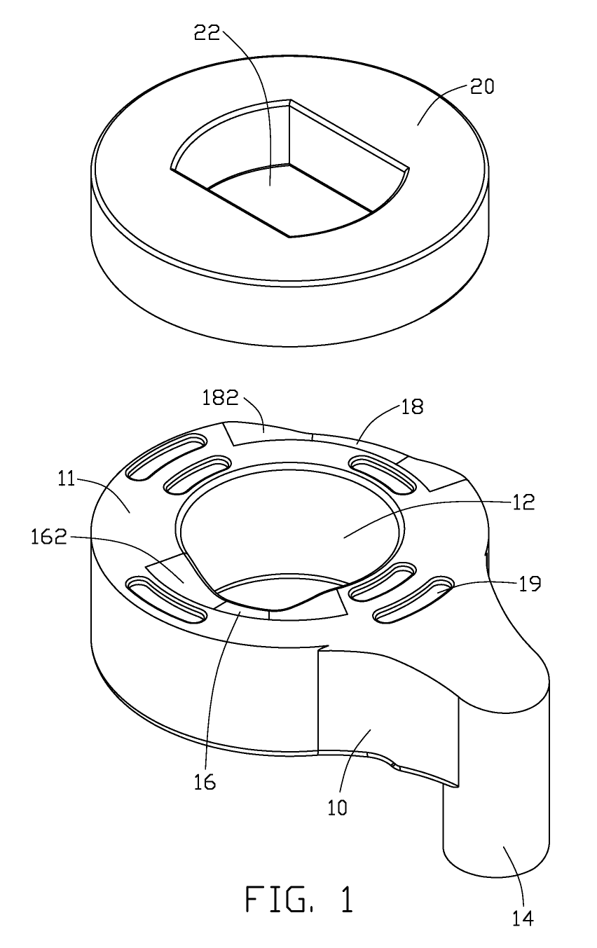

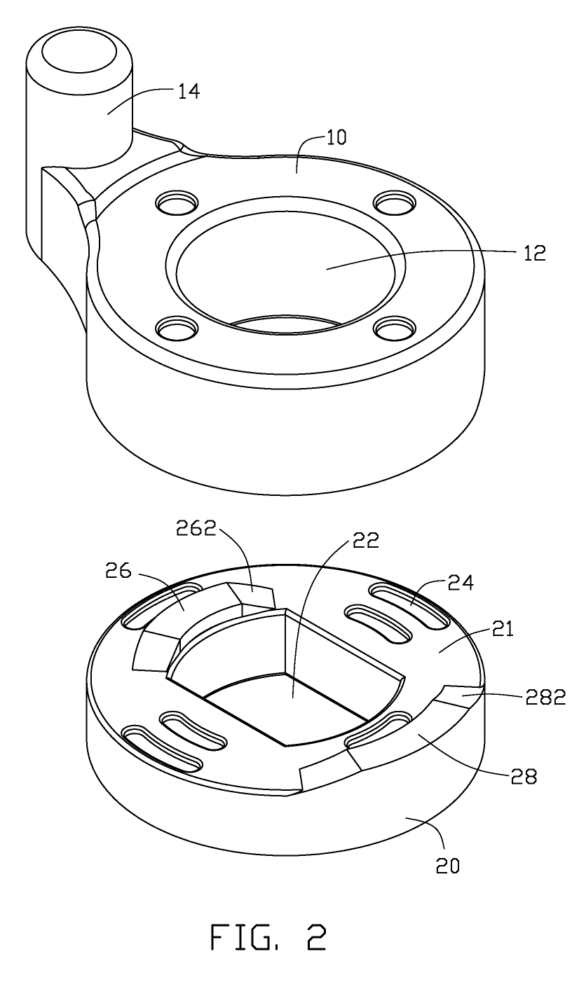

Referring to FIGS. 1 and 2, a cam interference assembly of a hinge 56 for a foldable device 50 includes a first element 10 and a second element 20.

The first element 10 is generally cylinder-shaped. The first element 10 defines a round through hole 12 in a central portion of the first element 10. The through hole 12 extends through a first mating surface 11 and out an opposite exposed surface, configured for receiving a non-cylindrical shaft (not shown). The first mating surface 11 defines an arc-shaped first depressed portion 16 and an arc-shaped second depressed portion 18 opposite to the first depressed portion 16. Each end of the first depressed portion 16 includes a slanting connecting surface 162 connecting a bottom of the first depressed portion 16 to the first mating surface 11. Each ends of the second depressed portion 18 includes a slanting connecting surface 182 connecting a bottom of the second depressed portion 18 to the first mating surface 11. A depth of the bottom of the first and second depressed portions 16, 18 from the first mating surface 11 may be substantially equal. In the illustrated embodiment, the first depressed portion 16 is adjacent to the through hole 12, and the second depressed portion 18 is adjacent to an edge of the first element 10 away from the through hole 12. In one embodiment, the depressed portions 16, 18 may both be adjacent to the through hole 12. In another embodiment, the depressed portions 16, 18 may both be adjacent to the edge of the first element 10 away from the through hole 12. The first mating surface 11 defines a plurality of recessed cavities 19 capable of retaining oil. A protrusion (not labeled) extends outwardly from a sidewall of the first element 10. A fastening post 14 extends from a distal end of the protrusion away from the first mating surface 11, and extends along an axial direction of the first element 10 configured for fixing the first element 10 to the foldable device 50.

The second element 20 is generally cylinder-shaped. A central portion of the second element 20 defines a non-circular fixing hole 22 having a substantially similar size and shape to the size and shape of the shaft, such that the shaft cannot rotate along a central axis of the shaft. A second mating surface 21 of the second element 20 faces the first mating surface 11. An arc-shaped first raised portion 26 protrudes from the second mating surface 21 and configured for engaging with the first depressed portion 16. Each end of the first raised portion 26 includes a slanting connecting surface 262 connecting a top of the first raised portion 26 and the second mating surface 21. An arc-shaped second raised portion 28 protrudes from the second mating surface 21 opposite to the first raised portion 26, and configured for engaging with the second depressed portion 18 of the first element 10. Each end of the second raised portion 28 includes a slanting connecting surface 282 connecting a top of the second raised portion 28 to the second mating surface 21. A height of the first and second raised portions 26, 28 may be substantially equal to the depth of the first and second depressed portions 16, 18. Depending on the embodiment, the first raised portion 26 and the second raised portion 28 are positioned so that when the first element 10 is mated to the second element 20, the first raised portion 26 is received in the first depressed portion 16, and the second raised portion 28 is received in the second depressed portion 18. The second mating surface 21 defines a plurality of recessed portions 24 capable of retaining oil.

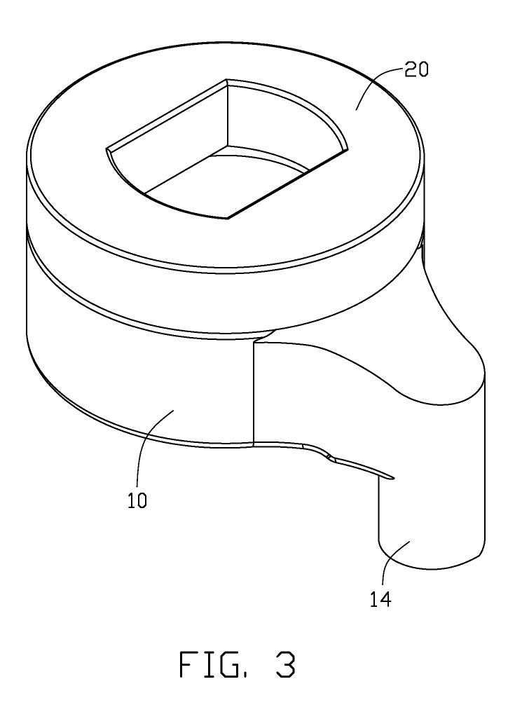

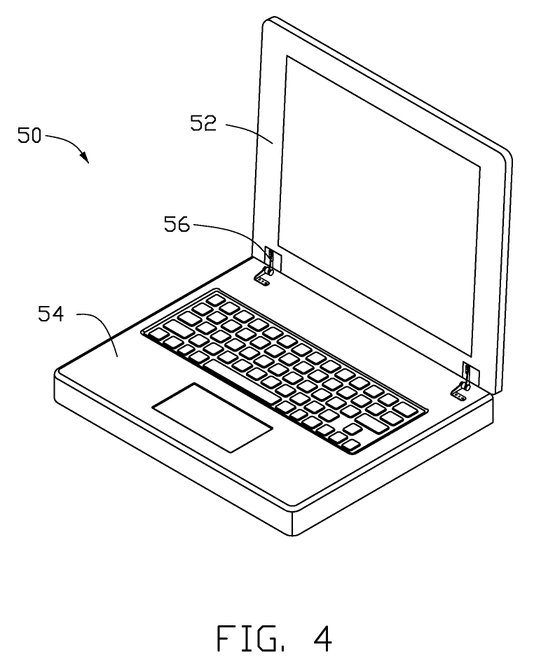

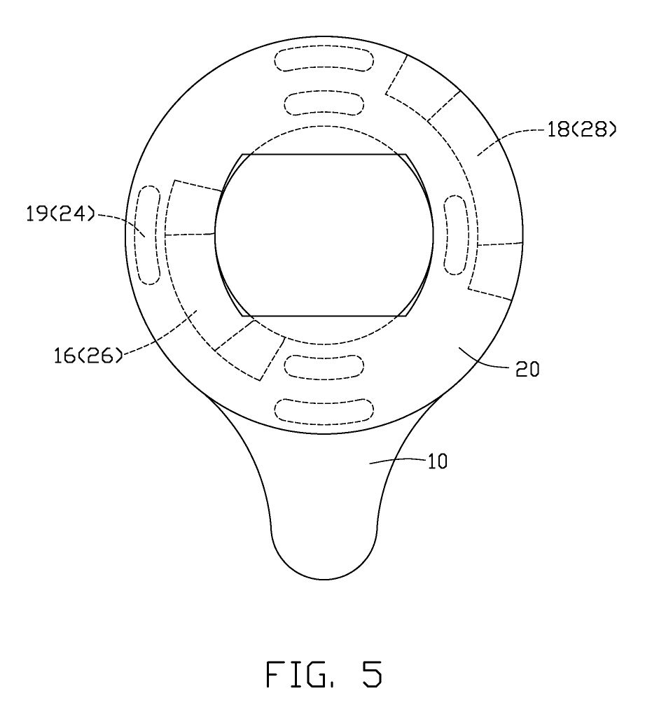

Referring also to FIGS. 3 through 5, the shaft extends through the through hole 12 and the fixing hole 22. The shaft may be rotatable in the through hole 12, but unmovable in the fixing hole 22. The first element 10 may be fixed to a base 54 of the foldable device 50 by the fastening post 14. The shaft and the second element 20 may be fixed to a cover 52 of the foldable device 50. When the cover 52 is folded to the base 54, the first element 10 is engaged with the second element 20, such that the first raised portion 26 is received in the first depressed portion 16 and the second raised portion 28 is received in the second depressed portion 18.

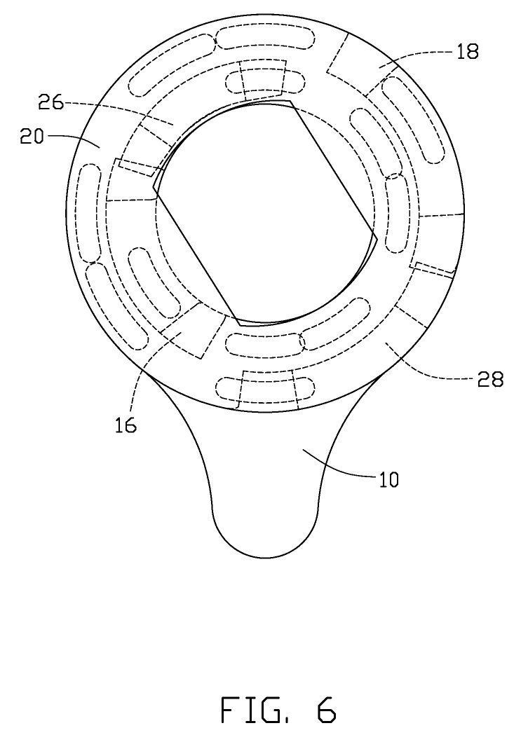

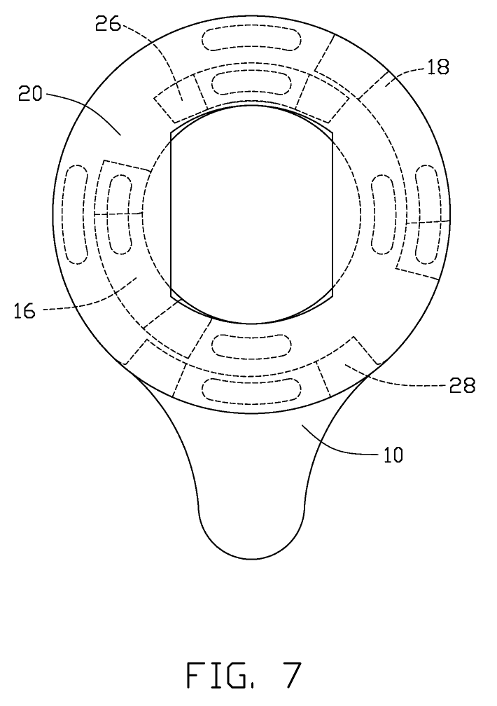

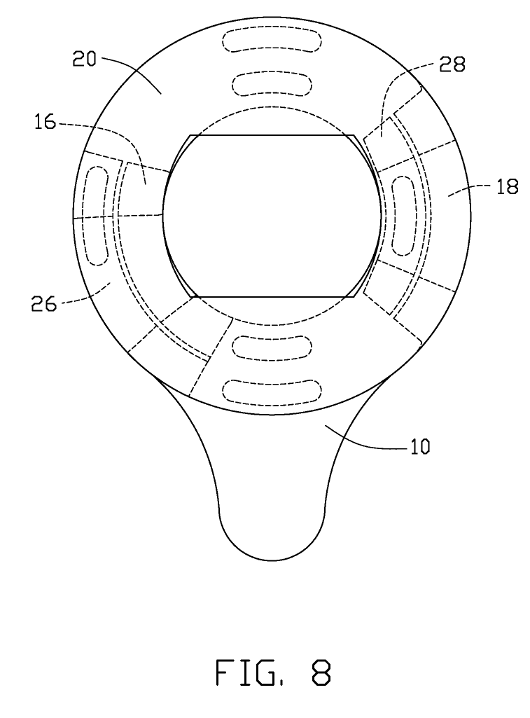

Referring also FIGS. 6 through 8, when the cover 52 is rotated away from the base 54, the second element 20 and the shaft are rotated with the cover 52, thereby causing the first raised portion 26 to slide along one of the connecting surfaces 162 and the second raised portion 28 to slide along one of the connecting surfaces 182. Accordingly, the first mating surface 11 is separated from the second mating surface 21 by a gap substantially equal to the height of the first and second raised portions 26, 28.

When closing the cover 52, the cover 52 is moved toward the base 54. As the closing movement continues, the first raised portion 16 slides along one of the connecting surfaces 162 to enter into the first depressed portion 16 and the second raised portion 28 slides along one of the connecting surfaces 182 to enter into the second depressed portion 18. At this moment, the cover 52 may be physically released because the cover 52 will continue to rotate by force of inertia, but lightly so as not to bump hard against the base 54. When the first and second raised portions 26, 28 are respectively engaged in the first and second depressed portions 16, 18, the cover 52 is closed to the base 54.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiments.

What is claimed is:

1. A cam interference assembly of a hinge, comprising:
a cylinder-shaped first element comprising:
a through hole defined in a central portion of the first element;
a plurality of depressed portions defined in a first mating surface of the first element; and
a plurality of first recessed cavities capable of retaining oil defined in the first mating surface; and
a cylinder-shaped second element comprising:
a fixing hole defined in a central portion of the second element;
a plurality of raised portions formed on a second mating surface of the second element and configured for engaging with the corresponding plurality of depressed portions; and
a plurality of second recessed cavities capable of retaining oil defined in the second mating surface;
wherein the first element is rotatable relative to the second element; the first mating surface and the second mating surface face each other.

2. The cam interference assembly of claim 1, wherein the through hole is circular.

3. The cam interference assembly of claim 1, wherein the fixing hole is non-circular.

4. The cam interference assembly of claim 1, wherein each of the plurality of depressed portions includes two slanting connecting surfaces at opposite ends, the slanting connecting surfaces connect a bottom of the depressed portion to the first mating surface.

5. The cam interference assembly of claim 1, wherein each of the plurality of raised portions includes two slanting connecting surfaces at opposite ends, the slanting connecting surfaces connect a top of the raised portion to the second mating surface.

6. The cam interference assembly of claim 1, wherein at least one of the plurality of depressed portions is adjacent to the through hole, and at least one of the plurality of depressed portions is adjacent to an edge of the first element.

7. The cam interference assembly of claim 1, wherein the plurality of depressed portions are adjacent to the through hole.

8. The cam interference assembly of claim 1, wherein the plurality of depressed portions are adjacent to the edge of the first element away from the through hole.

9. The cam interference assembly of claim 1, wherein a depth of each depressed portion from the first mating surface is substantially equal;
a height of each raised portion from the second mating surface is substantially equal to the depth of each depressed portion.

10. The cam interference assembly of claim 1, wherein a fastening post extends from a side of the first element away from the first mating surface along an axial direction of the first element and configured for fixing the first element.

11. A foldable device comprising:
a base;
a hinge comprising a cam interference assembly, the cam interference assembly comprising:
a cylinder-shaped first element comprising:
a through hole defined in a central portion of the first element;
a plurality of depressed portions defined in a first mating surface of the first element; and
a plurality of first recessed cavities capable of retaining oil defined in the first mating surface; and
a cylinder-shaped second element comprising:
a fixing hole defined in a central portion of the second element;
a plurality of raised portions formed on a second mating surface of the second element and configured for engaging with the corresponding plurality of depressed portions; and
a plurality of second recessed cavities capable of retaining oil defined in the second mating surface;
a cover pivotally mounted to the base via the hinge;
wherein a distal end of the hinge is fixed to the base, and a proximal end of the hinge is mounted to the cover; the first element is rotatable relative to the second element; the first mating surface and the second mating surface face each other.

12. The foldable device of claim 11, wherein the through hole is circular.

13. The foldable device of claim 11, wherein the fixing hole is non-circular.

14. The foldable device of claim 11, wherein each of the plurality of depressed portions includes two slanting connecting surfaces at opposite ends, the slanting connecting surfaces connect a bottom of the depressed portion to the first mating surface.

15. The foldable device of claim 11, wherein each of the plurality of raised portions includes two slanting connecting surfaces at opposite ends, the slanting connecting surfaces connect a top of the raised portion to the second mating surface.

16. The foldable device of claim 11, wherein at least one of the plurality of depressed portions is adjacent to the through hole, and at least one of the plurality of depressed portions is adjacent to an edge of the first element.

17. The foldable device of claim 11, wherein the plurality of depressed portions are adjacent to the through hole.

18. The foldable device of claim 11, wherein the plurality of depressed portions are adjacent to the edge of the first element away from the through hole.

19. The foldable device of claim 11, wherein a depth of each depressed portion from the first mating surface is substantially equal;
a height of each raised portion from the second mating surface is substantially equal to the depth of each depressed portion.

20. The foldable device of claim 11, wherein a fastening post extends from a side of the first element away from the first mating surface along an axial direction of the first element and configured for fixing the first element to the cover of the base.
